(19) United States
(12) Patent Application Publication
(10) Pub. No.: US 2006/0181401 A1
(43) Pub. Date: Aug. 17, 2006

(54) Vacation mode security system and method

(75) Inventor: Christopher D. Martin, Plainview, NY (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC

(21) Appl. No.: 11/048,449

(22) Filed: Jan. 31, 2005

(51) Int. Cl. G08B 29/00; G08B 13/00; G08B 23/00; G08B 1/00

(52) U.S. Cl. 340/506; 340/541; 340/528; 340/511; 340/531

(57) ABSTRACT

A security system for protecting a building which includes at least a first sensor and an alarm panel that includes a microprocessor and memory, said alarm panel having an armed mode, a disarmed mode and a vacation mode, said armed mode and said vacation mode differing with respect to the response to events occurring within the associated building. The invention also includes the method for protecting a building which includes providing at least a first sensor, providing an alarm panel that includes a microprocessor and memory, and providing the security system, normally the alarm panel with features that include an armed mode, a disarmed mode and a vacation mode. The armed mode and the vacation mode differ with respect to the response to events occurring within the associated building.

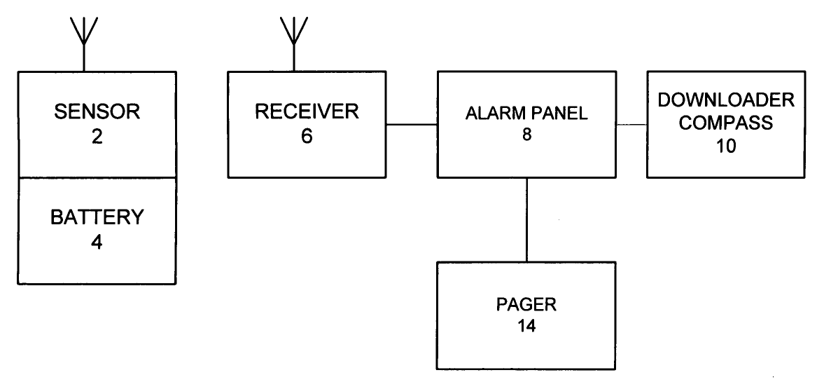

### FIELD OF THE INVENTION

The present invention relates to the field of security systems for homes and businesses and particularly to security systems and methods with vacation arming modes of operation. Increasing theft and violence demand improved security systems to prevent crime, vandalism and terrorism. Modern security systems can detect perimeter violations and entry intrusions.

### BACKGROUND OF THE INVENTION

It is customary for people to make preparations for the security of their residence or business when going on vacation. In some cases the inhabitant of the building will set timers in various rooms that will randomly turn lights on and off. Procedural techniques to avoid burglary are widely publicized, such as, not telling many people about your impending departure and suspending mail and newspaper delivery etc. Some security systems include apparatus for randomly turning on lights in a building during a vacation mode. The prior art security systems have provided some vacation mode operations that have not been wholly satisfactory.

### SUMMARY OF THE INVENTION

It is an object of the present invention to provide a security system having innovative control possibilities that have not been suggested by the prior art.

Another object of the invention is to provide a security system that is more responsive to the needs and wishes of the user.

It has now been found that these and other objects the of the invention may be attained in a security system for protecting specific premises which includes at least a first sensor and an alarm panel that includes a microprocessor and memory. The alarm panel has an armed mode, a disarmed mode and a vacation mode. The armed mode and the vacation mode differ with respect to the response to events occurring within the associated building.

In some embodiments of the invention the system also randomizes the operation of lights in the associated building, allows the end-user to define the number of days for vacation mode operation, allows the end-user to eliminate the entry delay during vacation mode operation, and/or directs event reports relating to open/close events are directed to an associated pager (or email, etc) during vacation mode operation. In some embodiments, during vacation mode operation, arming and disarming of the system is reported to an associated pager and the alarm panel includes a voice dialer or a dialer that transmits a predetermined message to an associated pager. Some embodiments may also include an alarm panel or other parts of the security system that allow the end-user to specify the day of departure and day of return and/or specify to specify the day of departure and day of return in advance of the actual departure day. Other embodiments may also disable RF input devices including RF key fobs and RF keypads in vacation mode and may require the user to use a keypad to disarm the system. Some embodiments may include a relay or other apparatus to disable an associated garage door opener when the system is in vacation mode.

The invention also includes the method for protecting a building which includes providing at least a first sensor, providing a security system including an alarm panel that includes a microprocessor and memory that provide the security system with features that include an armed mode, a disarmed mode and a vacation mode. The armed mode and the vacation mode differ with respect to the response to events occurring within the associated building.

Some forms of the method for protecting a building include providing an alarm panel feature that randomizes the operation of lights the associated building, providing an alarm panel feature that enables the end-user to define the number of days for vacation mode operation, providing an alarm panel feature that allows entry delay to be eliminated during vacation mode operation, and/or providing a vacation mode operation event reports relating to open/close events to be directed to an associated pager (or email, or a central station).

Some embodiments of the method for protecting a building include providing an alarm panel feature that causes disarming of the system to be reported to an associated pager, providing a voice dialer in the alarm panel, providing a dialer that transmits predetermined messages to an associated pager from the alarm panel, providing a feature in the alarm panel that allows the end-user to specify the day of departure and day of return and/or providing a feature in the alarm panel that allows the and user to specify the day of departure and day of return to specify these dates in advance of the actual departure day. Other embodiments of the method may also include the step of disabling RF key fobs in vacation mode and include the step of requiring the user to use a keypad to disarm the system. Some embodiments of the method may include providing a relay or other apparatus to disable an associated garage door opener when the system is in vacation mode.

### BRIEF DESCRIPTION OF THE DRAWING

The invention will be better understood by reference to the accompanying drawing which is a diagrammatic view of a wireless security system incorporating the present invention.

### DESCRIPTION OF THE PREFERRED EMBODIMENTS

The prior art includes a variety of security systems intended for homeowners, business owners, and other potential targets for burglary, that are monitored by a central station. These systems are vastly superior to older systems that merely sound a bell or alarm. They have also largely replaced systems that were tied in directly to the local police station. As the use of burglar alarms increased, the local police departments began turning down more and more requests to be “hooked-up.” As a result, there became a demand for central stations, or companies whose specialty it was to simply monitor burglar alarms. Most police departments will still allow banks and large jewelry stores a direct link to the police station, but as a rule, homeowners are excluded. As the demand for security has risen, many guard agencies and burglar alarm installers have begun to offer centralized monitoring as an option for their clients.

When such systems are installed, it is common for them to be connected by a dedicated telephone line to the central station. Other systems utilize radio frequency and the internet to connect to the central station. In the event of an intrusion, the control panel (also known as a security panel) on the premises being monitored calls up the central station and gives an electronic message to the answering computer. It tells the computer exactly which switch or sensor has been violated, and the computer then tells the operator what has happened. For example if a burglar entered through a broken window, the panel would connect with the central station computer and tell it that zone 4, a first floor window, has been broken. The operator would then see on his computer screen that Acct. #1234, the Johnson residence has had zone 4, the window foiling on the living room window, violated. As the thief progresses through the house, the panel would call the central station for every sensor that was violated. The operator may then receive 1234-17, meaning that zone 17, a passive Infra-Red detector in the master bedroom, has detected someone. In some cases pre-amplified microphones allow audio monitoring of the protected premises. The operator would then be fairly sure someone was in the house, so the operator would have three options. The operator may just send the companies guards to the scene, call 911 and dispatch the police, or he may send both the police and the guards.

Passive infrared alarms are so called because they do not emit Infrared energy, but merely detect a change in Infrared energy. A PIR sensor probes its monitoring area, and if any changes are detected in Infrared (heat), it triggers an alarm. A PIR records the ambient room temperature so it will notice any changes in IR such as those that are produced by the human body. Slow temperature changes, such as thermostatically controlled heating systems, will not interfere with the PIR's function.

The present invention may be utilized in security systems that include wireless connections between the control panel and the individual sensors as well as systems having wired connections between the sensors and the control panel.

Referring now to the drawing, there is shown a conventional sensor, such as a passive infrared (PIR) sensor 2 coupled to a battery 4, that includes an internal transmitter and an antenna for transmitting a signal corresponding to the sensed parameter. Commercially available devices of this type are manufactured and sold by Honeywell and identified by the designation Ademco 5890 or 5894. Customarily the wireless sensor 2 is constructed and programmed to issue a signal at a predetermined interval to confirm the presence and operability of the sensor 2. For example, such a signal may be sent at an interval of once every hour to confirm to an alarm panel that the sensor has not been stolen or become inoperative.

The signal from the sensor 2 is transmitted to a receiver 6 that is configured to receive the signal from the sensor 2. Commercially available devices of this type are manufactured by Honeywell and are identified by the designation Ademco 5881.

The receiver 6 is physically connected to an alarm panel 8. A commercially available alarm panel 8 for such an application is manufactured by Honeywell and identified by the designation VISTA 50.

Typically, the alarm panel 8 may be coupled by a phone line to a microcomputer running control software whereby the alarm panel 8 may be remotely controlled. One commercially available software program for such purposes is marketed by Honeywell and identified as the Ademco Compass Downloader 10. This software permits a user to remotely program and control an alarm system. The software is fully compatible with Novell® & Lantastic® networks. It can simultaneously download from multiple workstations and can provide a complete account change/history. It provides a seamless DOS conversion and advanced error checking. There are multiple definable fields that can program and control any ADEMCO Group security system. Important features include permitting scheduled communication requests for the control panels. For example, the software may schedule a download of user codes to a customer at 2:00AM, or schedule an event log update from a customer on Friday at midnight. The software also provides support for Fire Burglary Instruments (FBII) and Apex control panels. In addition the software also simplifies updating so that new panels or changes can be added as a patch to the latest version of Compass. In addition the software supports the soon-to-be released Communications Interface Adapter (CIA) which provides error free remote communications between ADEMCO Group control panels and the Compass Downloader. This external modem connects to one of the COM ports of the Compass computer and the outside phone line used for communications to the control panel.

The Ademco Compass Downloader for Windows Software provides a quick and easy method for planning, designing and communicating with the alarm panels. The user may do so from the comfort of an office and will allow the user to download and upload alarm control information, to compare the upload and saved information, and to view the results either on a screen or any printed report. The Compass Downloader enables programming from an office prior to installation. Alternatively, initial programming can be downloaded from a remote location or at a job site using a personal computer with a commercially available serial module such as the Honeywell/Ademco 4100SM (where the alarm panel supports it). The Compass change feature reviews all system changes initiated by the download operator within the current session. A complete record of system modifications and the history of an account are also available.

Such security systems include an alarm or control panel 8 that includes a microprocessor and cooperating memory coupled by an appropriate data bus. The present invention may be implemented by providing software to achieve the objects of the present invention. While it is the preferred embodiment of the present invention to implement the objects thereof with software, those skilled in the art will recognize that the various logical steps could also be achieved with hardware. The construction of such hardware, upon of exposure to the teachings of the present application, will be obvious to those skilled in the art.

Presently, security systems include several different modes of operation. The modes are set by the end user at the time they arm their security system. Some of the modes are explained below. The user generally enters their 4-digit user code followed by the appropriate key to select the mode of arming/disarming.

The system shown in the drawing illustrates a wireless system. Those skilled in the art will recognize that other embodiments of the invention may be hardwired. The alarm panel 8 includes a microprocessor and memory and which cooperates with software that is commercially available or within the skill of practitioners in the programming arts. The software will include, for example, the following arming options in accordance with one form of the present invention: These arming options are typically performed via keypad keystrokes, key fobs. or similar input means

User Code+AWAY[2 key]

Arms the security system in the AWAY mode. This mode will be used when the occupants will be leaving the home for an extended time period.

The system allows an Exit Delay time so that they may leave through the entry/exit door.

The system allows an Entry Delay so that when the occupant returns to the home and opens the entry/exit door, the entry delay begins and they have xx seconds to disarm the system or an alarm will occur.

User Code+STAY[3 key]

Arms the system in the STAY mode. This mode will be used when the occupants will be staying in the home.

All Interior type zones are bypassed (motion detectors).

Perimeter zones (windows and doors) are armed

User Code+Off [1 key]

Disarms the system.

Known arming modes that disable the entry delay are known in the security system field as “Maximum” and “Instant”.

The present system and method includes a new arming method (User Code+X, TBD) for use when homeowners will be away from their home or business for an extended period of time (e.g., On Vacation). There are some special needs to be taken when going on a vacation for an extended period of time that normal away arming may not cover. This mode will allow the end user to arm their security system in such a way that when they go on a vacation an array of options go in to effect as listed in the next section. The arming mode in accordance with the system and method of the present invention optionally includes some or all of the following features:
1. Automatically randomize lights during the evening. The security system and method in accordance with the present invention optionally allows the control of lights and appliances via X10 modules such as those manufactured by X10 Wireless Technology, Inc. of Seattle, Wash. One form of the system in accordance with the present invention has a number of programmable outputs and schedules that turn these lights on and off at programmed times of the day or night. This new option can randomize the lights in the home when on vacation. Similarly, other options can also activate triggers built into the control panel or relays added to the control panel.
2. Optionally send a unique Contact ID code (or other code) to the central station so the central station operators know that the homeowner is on vacation; sends another Vacation End code when homeowners are back and disarm the system. As described above most security systems are monitored by a central station. Reports are sent for alarms and such. This feature will send a special report code to notify the central station that a specific system has been armed in the Vacation Mode and when the Vacation Mode has been disarmed. The central station will ordinarily handle alarm reports differently if they know the end user is not in the premises.
3. Optionally disable any burglary report delays so alarms report immediately to central station. Most conventional security systems have a programmable delay (15-60 seconds) that prevents a burglary report from being sent to the central station until this time delay has expired. If the user disarms the system before this delay expires, no report is sent. This is a false alarm reduction feature. In Vacation Mode, this delay may be optionally be modified, for example, this delay may be disabled to allow alarm reports to be sent instantly or the delay may be lengthened or shortened.
4. Optionally allow the end user to program how many days they will be away and the entry delay is eliminated for that period of time. Thus, there will be an immediate alarm when an entry door is opened while the homeowner is on vacation.
5. Optionally provide a method and apparatus to disable any entry delay so that an instant alarm occurs when an entry door is opened. This is in contrast to conventional systems that provide an entry delay to allow the end user to open the entry door and disarm the system so an alarm condition does not occur. Similarly, some system may include timers and/or schedulers (referred to herein collectively as “schedulers”) for various events such as turning on a coffee pot at a predetermined time. Some embodiments of the present invention include the apparatus and method to selectively disable any one of schedulers.
6. Optionally report selected open/close signals only when the security system is in vacation mode such as when an authorized person is taking care of a dog or some other authorized task. The end user may not want open and close signals sent at other times. Open and Close signals are reports that are sent to the central station each time the system is armed (opened) or disarmed (closed). Generally, these reports are used in commercial applications and require additional monitoring fees. In Vacation Mode, an option may allow these reports to be sent only while in Vacation Mode so the central station or end user (via pager, etc.) can be notified if anyone disarms or arms the system (e.g., house-sitter, unauthorized visitor).
7. Optionally, if there is a pager or email module or programming enabled, all reports are automatically enabled to be sent or other selected report including but not limited to open, close, alarms, troubles, etc. In various embodiments of the invention the alarm panel 8 may include a voice dialer or pager dialer which may be connected to a hardwired phone or to a mobile phone. In some cases the alarm panel includes a speech dialer or a dialer that transmits codes to a pager. Those skilled in the art will recognize that the speech dialer is designed for verbal reporting of alarm; emergency and technical events. Some such devices are multi-channel devices. For example, a four channel automatic voice dialer may include a busy-line and no-answer detection to ensure prompt transmission of up to four pre-recorded messages delivered sequentially to as many as eight standard telephones, cellular phones, voice and/or numeric pagers. Messages to both local and long-distance numbers can be transmitted when activated; the dialer instantly begins calling the numbers in sequence delivering each message one to three times in a row, in accordance with a pre-selected number of dialing attempts. More modern and/or sophisticated systems use central stations, email, pagers, etc.

The respective methods and systems in accordance with the present system may utilize an alarm panel 8 that includes a microprocessor and memory and which cooperates with software that is commercially available or within the skill of practitioners in the programming field. It will be appreciated that the systems and methods of the present invention are described with reference to block diagram illustrations. It should be understood that blocks of the block diagrams illustrations, and combinations of blocks in the block diagrams illustrations, respectively, may be implemented by computer program instructions. These computer program instructions may be loaded onto a general purpose computer, special purpose computer, or other programmable data processing apparatus to produce a mechanism, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the functions specified herein. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified herein.

Accordingly, blocks of the block diagrams illustration support combinations of means for performing the specified functions, combinations of steps for performing the specified functions and program instruction means for performing the specified functions. It will also be understood that each block of the block diagrams illustration, and combinations of blocks in the block diagrams illustrations, can be implemented by special purpose hardware-based computer systems that perform the specified functions or steps, or combinations of special purpose hardware and computer instructions.

While the invention has been described in terms of control functions disposed at an alarm panel 8, it will be understood that in other embodiments of the invention these control functions may be disposed at other parts of the system.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. A security system for protecting a building which comprises:
at least a first sensor;
an alarm panel that includes a microprocessor and memory;
said alarm panel having an armed mode, a disarmed mode and a vacation mode, said armed mode and said vacation mode differing with respect to the response to events occurring within the associated building.

2. The security system as described in claim 1 wherein the system also randomizes the operation of lights in the associated building during vacation mode.

3. The security system as described in claim 1 wherein the end-user may define the number of days for vacation mode operation.

4. The security system as described in claim 1 wherein entry delay is selectively modified during vacation mode operation.

5. The security system as described in claim 1 wherein during vacation mode operation event reports relating to open/close events are directed to an associated display selected from the group that includes a pager, email, and a central station.

6. The security system as described in claim 1 wherein arming and disarming of said system is reported to an associated pager.

7. The security system as described in claim 1 wherein said security system includes a voice dialer.

8. The security system as described in claim 1 wherein said security system includes a dialer that transmits predetermined calls to an associated pager.

9. The security system as described in claim 1 wherein said security system allows the end-user to specify the day of departure and day of return.

10. The security system as described in claim 1 wherein said security system allows the end-user to specify the day of departure and day of return in advance of the actual departure day.

11. A method for protecting a building which comprises:
providing at least a first sensor;
providing an alarm panel that includes a microprocessor and memory; and
providing the alarm panel with features that include an armed mode, a disarmed mode and a vacation mode, said armed mode and said vacation mode differing with respect to the response to events occurring within the associated building.

12. The method for protecting a building as described in claim 11 further including providing an alarm panel feature that randomizes the operation of lights in the associated building.

13. The method for protecting a building as described in claim 11 further including providing an alarm panel feature that enables the end-user to define the number of days for vacation mode operation.

14. The method for protecting a building as described in claim 11 further including providing an alarm panel feature that allows entry delay to be modified during vacation mode operation.

15. The method for protecting a building as described in claim 11 further including providing an alarm panel feature that allows vacation mode operation event reports relating to open/close events to be directed to an output that is selected from the group consisting of a pager, email and a central station.

16. The method for protecting a building as described in claim 11 further includes providing an alarm panel feature that causes disarming of the system to be reported to an associated pager.

17. The method for protecting a building as described in claim 11 that further includes providing a voice dialer in the alarm panel.

18. The method for protecting a building as described in claim 11 that further includes providing a dialer that transmits predetermined message to an associated pager from the alarm panel.

19. The method for protecting a building as described in claim 11 that further includes providing a feature in the alarm panel that allows the end-user to specify the day of departure and day of return.

20. The method for protecting a building as described in claim 19 wherein the step of providing a feature in the alarm panel that allows the and user to specify the day of departure and day of return to specify these dates in advance of the actual departure day.

21-37. (canceled)
